(19) United States
(12) Patent Application Publication
(10) Pub. No.: US 2022/0153624 A1
(43) Pub. Date: May 19, 2022

(54) CASTING STRUCTURE ALLOWING INLAYED INNER AND OUTER MEMBER TO BE VIEWED

(71) Applicant: Chih-Chieh LIN, Taipei City (TW)

(72) Inventor: Chih-Chieh LIN, Taipei City (TW)

(21) Appl. No.: 17/220,139

(22) Filed: Apr. 1, 2021

(30) Foreign Application Priority Data
Nov. 18, 2020 (TW) 109215215

(51) Int. Cl. C03B 19/02; B44B 9/00

(52) U.S. Cl. CPC C03B 19/02; B44B 9/00

(57) ABSTRACT

A casting structure allowing inlayed inner and outer member to be viewed includes: at least one inner member, formed as a three-dimensional shape; an outer member, formed with an inlaying space for allowing the inner member to be combined and inlayed therein, wherein the outer member is a three-dimensional shape formed through a material capable being viewed through; and a filling material member, made of a material capable of being viewed through and filled at an outer side of the outer member inlayed with the inner member so as to form a casting member; wherein, with the inner member being inlayed in the outer member, the filling material member is able to enclose and to be processed with a casting operation for forming the casting member capable of being viewed through.

### BACKGROUND OF THE INVENTION

### 1. Field of the Invention

The present invention relates to a casting structure, especially to a casting structure allowing inlayed inner and outer member to be viewed.

### 2. Description of Related Art

A conventional decorative member is mostly formed through carving a transparent or opaque material so as to form a finished product; due to the structural limitation, an inner member is unable to be inlayed inside the finished product, thus the inner structure cannot be viewed through for increasing decorative and fun effects, moreover, the finished product cannot be easily formed through a massive production by utilizing a mold or a formation structure; as such, the conventional finished product is unable to be provided with alternations, the cost is high and the production is labor and time consuming, thus the practicability is very much limited; as such, the above-mentioned shortages shall be improved by the skilled people in the art.

### SUMMARY OF THE INVENTION

For solving the shortages existed in the prior art, one primary objective of the present invention is to provide a casting structure allowing inlayed inner and outer member to be viewed, in which an inner member is inlayed in an outer member, and a filling material member is served to enclose an outer side of the outer member, thereby solving the shortages existed in the prior art.

Another objective of the present invention is to provide a casting structure allowing inlayed inner and outer member to be viewed, in which a filling material member made of a material capable of being viewed through is processed with a casting operation for enclosing an outer member allowing an inner member which is inlayed therein to be viewed, thereby forming a casting member.

One another objective of the present invention is to provide a casting structure allowing inlayed inner and outer member to be viewed, which has advantages effectively increasing functions of providing fun, decorative and value.

The problem to be solved by the present invention is that: a conventional decorative member is mostly formed through carving a transparent or opaque material so as to form a finished product; due to the structural limitation, an inner member is unable to be inlayed inside the finished product, thus the inner structure cannot be viewed through for increasing decorative and fun effects, moreover, the finished product cannot be easily formed through a massive production by utilizing a mold or a formation structure; as such, the conventional finished product is unable to be provided with alternations, the cost is high and the production is labor and time consuming, thus the practicability is very much limited.

For achieving the aforesaid objectives, one technical solution provided by the present invention is to provide a casting structure allowing inlayed inner and outer member to be viewed, characterized in including:

at least one inner member, formed as a three-dimensional shape;

an outer member, formed with an inlaying space for allowing the inner member to be combined and inlayed therein, wherein the outer member is a three-dimensional shape formed through a material capable being viewed through; and a filling material member, made of a material capable of being viewed through and filled at an outer side of the outer member inlayed with the inner member so as to form a casting member;

wherein, with the inner member being inlayed in the outer member, the filling material member is able to enclose and to be processed with a casting operation for forming the casting member capable of being viewed through.

Wherein, according to the present invention, the three-dimensional shape of the inner member includes, but not limits to, a three-dimensional pattern, a three-dimensional image or a three-dimensional text.

Wherein, according to the present invention, the three-dimensional shape formed by the inner member is a transparent three-dimensional shape or an opaque three-dimensional shape or a translucent three-dimensional shape.

Wherein, according to the present invention, the transparent three-dimensional shape or the opaque three-dimensional shape or the translucent three-dimensional shape formed by the inner member is a silicon dioxide material or a non-silicon-dioxide material.

Wherein, according to the present invention, the silicon dioxide material of the three-dimensional shape formed by the inner member includes, but not limits to, a crystal, a crystal glass or a glass.

Wherein, according to the present invention, the inner member is able to form the three-dimensional shape through a massive production by utilizing a mold or through a means of being directly formed.

Wherein, according to the present invention, the outer member is formed with the three-dimensional shape through a massive production by utilizing a mold.

Advantages achieved by the present invention are as follows: the inner member is inlayed in the outer member, the filling material member is served to enclose the outer side of the outer member; as such, the filling material member made of the material capable of being viewed through is processed with a casting operation for enclosing the outer member made of the material capable of being viewed through and inlayed with the inner member, thereby forming the casting member; functions of providing fun, decorative and value can be effectively increased; accordingly, the present invention is novel and more practical in use, and can satisfy requirements of the consumers.

### BRIEF DESCRIPTION OF THE DRAWINGS

FIG. 1 is a perspective exploded view according to the present invention;

FIG. 2 is a perspective view showing the assembly according to the present invention;

FIG. 3 is a cross sectional view showing the assembly according to the present invention; and

FIG. 4 is a flowchart showing a process for forming a casting member according to the present invention.

### DETAILED DESCRIPTION OF THE PREFERRED EMBODIMENT

One preferred embodiment of the present invention will be described with reference to the drawings for illustrating the structural assembly, the technical means and the functions to be achieved by the present invention; and the actual ratios and the arrangement of components shall not be limited by the ratios and the arrangement of components in the provided figures.

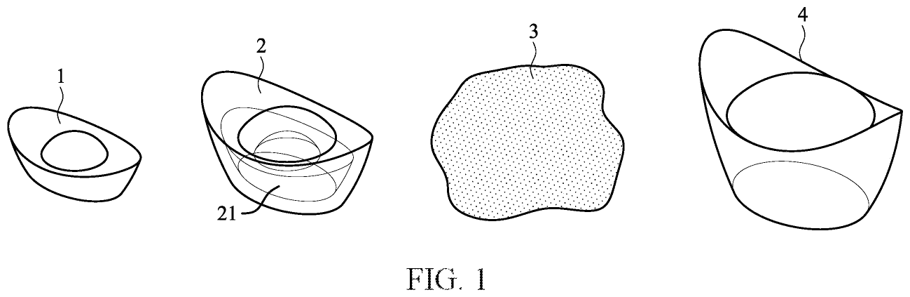

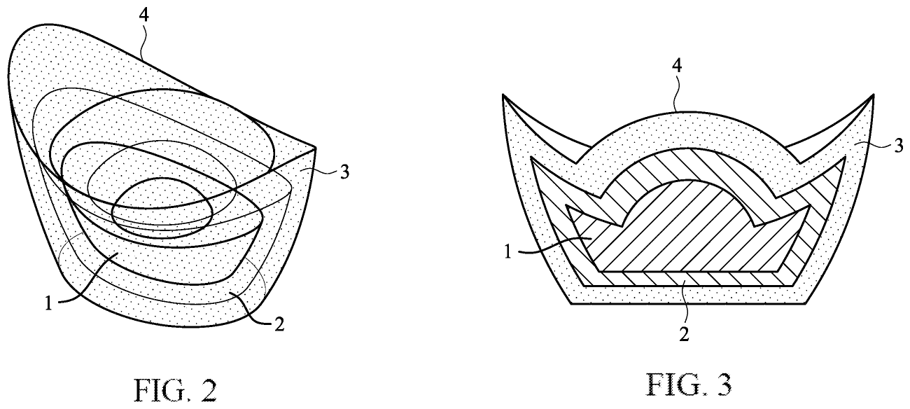

Please refer from FIG. 1 to FIG. 3, wherein FIG. 1 is a perspective exploded view according to the present invention; FIG. 2 is a perspective view showing the assembly according to the present invention; FIG. 3 is a cross sectional view showing the assembly according to the present invention. According to one preferred embodiment of the present invention, a casting structure allowing inlayed inner and outer members to be viewed is disclosed and characterized in including: at least one inner member 1, an outer member 2 and a filling material member 3.

The at least one inner member 1 is formed as a three-dimensional structure; the three-dimensional shape of the inner member 1 includes, but not limits to, a three-dimensional pattern, a three-dimensional image or a three-dimensional text, the three-dimensional shape formed by the inner member 1 is a transparent three-dimensional shape or an opaque three-dimensional shape or a translucent three-dimensional shape; the transparent three-dimensional shape or the opaque three-dimensional shape or the translucent three-dimensional shape formed by the inner member 1 is a silicon dioxide material or a non-silicon-dioxide material; the silicon dioxide material of the three-dimensional shape formed by the inner member 1 includes, but not limits to, a crystal, a crystal glass or a glass; according to this embodiment, the inner member 1 is able to form the three-dimensional shape through a massive production by utilizing a mold or through a means of being directly formed.

The outer member 2 is formed with an inlaying space 21 for allowing the inner member 1 to be combined and inlayed therein, the outer member 2 is a three-dimensional shape formed through a material capable of being viewed through; according to this embodiment, the outer member 2 can be formed with the three-dimensional shape through a massive production by utilizing a mold.

The filling material member 3 is made of a material capable of being viewed through and filled at an outer side of the outer member 2 inlayed with the inner member 1 so as to form a casting member 4; with the inner member 1 being inlayed in the outer member 2, the filling material member 3 is able to enclose and to be processed with a casting operation for forming the casting member 4 capable of being viewed through.

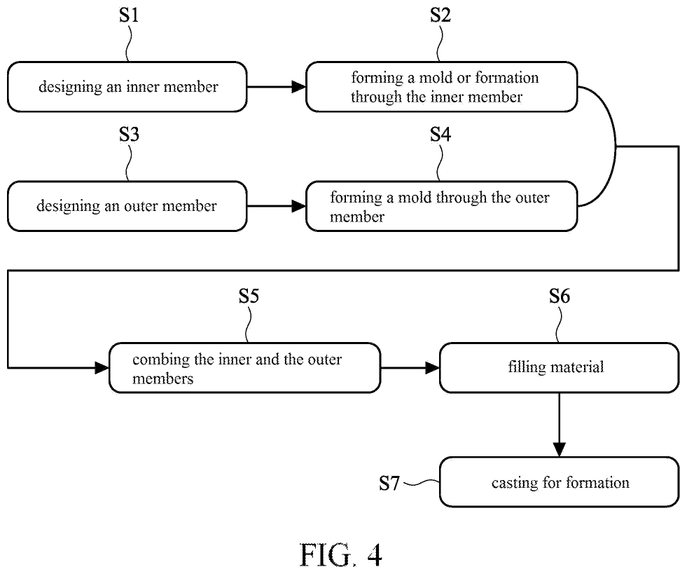

Please refer to FIG. 4, which is a flowchart showing a process for forming a casting member according to the present invention. The present invention provides a process for forming the casting member 4, which includes: designing an inner member S1; forming a mold or formation through the inner member S2; designing an outer member S3; forming a mold through the outer member S4; combing the inner and the outer members S5 through the S2 of forming the mold or the formation of the inner member and the S4 of forming the mold through the outer member; filling material S6 for enclosing; and casting for formation S7.

Accordingly, according to the present invention, the inner member 1 is inlayed in the outer member 2, the filling material member 3 is served to enclose the outer side of the outer member 2; as such, the filling material member 3 made of the material capable of being viewed through is processed with a casting operation for enclosing the outer member 2 allowing the inner member 1 which is inlayed therein and can be viewed, thereby forming the casting member 4; functions of providing fun, decorative and value can be effectively increased; accordingly, the present invention is novel and more practical in use, and can satisfy requirements of the consumers.

What is claimed is:

1. A casting structure allowing inlayed inner and outer member to be viewed, characterized in including:
at least one inner member, formed as a three-dimensional shape;
an outer member, formed with an inlaying space for allowing the inner member to be combined and inlayed therein, wherein the outer member is a three-dimensional shape formed through a material capable being viewed through; and
a filling material member, made of a material capable of being viewed through and filled at an outer side of the outer member inlayed with the inner member so as to form a casting member;
wherein, with the inner member being inlayed in the outer member, the filling material member is able to enclose and to be processed with a casting operation for forming the casting member capable of being viewed through.

2. The casting structure allowing inlayed inner and outer member to be viewed as claimed in claim 1, wherein the three-dimensional shape of the inner member includes, but not limits to, a three-dimensional pattern, a three-dimensional image or a three-dimensional text.

3. The casting structure allowing inlayed inner and outer member to be viewed as claimed in claim 1, wherein the three-dimensional shape formed by the inner member is a transparent three-dimensional shape or an opaque three-dimensional shape or a translucent three-dimensional shape.

4. The casting structure allowing inlayed inner and outer member to be viewed as claimed in claim 3, wherein the transparent three-dimensional shape or the opaque three-dimensional shape or the translucent three-dimensional shape formed by the inner member is a silicon dioxide material or a non-silicon-dioxide material.

5. The casting structure allowing inlayed inner and outer member to be viewed as claimed in claim 4, wherein the silicon dioxide material of the three-dimensional shape formed by the inner member includes, but not limits to, a crystal, a crystal glass or a glass.

6. The casting structure allowing inlayed inner and outer member to be viewed as claimed in claim 1, wherein the inner member is able to form the three-dimensional shape through a massive production by utilizing a mold or through a means of being directly formed.

7. The casting structure allowing inlayed inner and outer member to be viewed as claimed in claim 1, wherein the outer member is formed with the three-dimensional shape through a massive production by utilizing a mold.
